(19) United States
(12) Patent Application Publication
(10) Pub. No.: US 2005/0286354 A1
(43) Pub. Date: Dec. 29, 2005

(54) Optical pick-up device

(75) Inventors: Yasuhiro Shinkai, Kawagoe (JP); Eiji Takahashi, Kawagoe (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 11/149,211

(22) Filed: Jun. 10, 2005

(30) Foreign Application Priority Data
Jun. 23, 2004 (JP) 2004-184968

(51) Int. Cl. G11B 7/00

(52) U.S. Cl. 369/44.14; 369/44.11

(57) ABSTRACT

For providing an optical pick-up device, in which can prevent sound noise, the optical pick-up device includes a moving base, actuator assembly, an elastic rod and a buffer sheet. The moving base can move freely in a radial direction of an optical disk. The actuator assembly mounted on the moving base reads data on the optical disk. The elastic rod supports the actuator assembly movably in a focusing direction and a tracking direction. The buffer sheets are bonded on the moving base to abut on the actuator assembly. The buffer sheets are provided separately to each other in a direction perpendicular to lengthwise of the elastic rod to place a center of gravity CG of the actuator assembly therebetween.

### BACKGROUND OF THE INVENTION

1. Field of the Invention

This invention relates to an optical pick-up device to move freely an actuator assembly for reading data along a radius direction of an optical disk.

2. Description of the Related Art

Generally, an optical pick-up device for reading data stored on an optical disk, such as a compact disk (CD), a digital versatile disk (DVD) and the like, includes a moving base, an actuator assembly and an elastic rod.

The moving base can move freely in a radial direction of the optical disk. The actuator assembly reads data stored on the optical disk by irradiating the optical disk with a laser beam. The actuator assembly is mounted on the moving base so as to move freely in a direction to and from the optical disk (call a focusing direction hereafter) and in the radial direction of the optical disk (call a tracking direction hereafter) for reading data stored in the optical disk. The actuator assembly has a coil for moving it in the focusing direction and in the tracking direction against the moving base by applying voltage to the coil.

A plurality of elastic rods is provided. One end of the elastic rod is joined to the moving base, and the other end of the elastic rod is joined to the actuator assembly. The elastic rods make the actuator assembly capable of moving freely in the focusing direction and in the tracking direction against the moving base.

The optical pick-up device structured as mentioned above forms an optical disk playback apparatus for reading data stored on the optical disk. Such optical disk playback apparatus is installed at a car as a vehicle. In the optical disk playback apparatus installed in the car, the optical pick-up device moves possibly in the focusing direction against the moving base without applying voltage to the coil, that is, when not in use.

When the actuator assembly moves close to the moving base apart from the optical disk in the focusing direction, the actuator assembly will strike the moving base. The actuator assembly vibrates against the moving base by vibration in running car, and makes sound noise by repeating to strike the moving base.

For preventing such sound noise, Patent reference 1 proposed to mount a buffer sheet on the moving base. According to the Patent reference 1, by mounting the buffer sheet on a position, on which the actuator assembly abuts possibly, of the moving base, it is prevented that the actuator assembly strikes the moving base.

The patent reference 1 is Japan Patent Application Laid-open H9-320079.

Objects to be Solved

If only the buffer sheet is mounted on the moving base according to the aforesaid Patent reference 1, the elastic rods are possibly twisted with over elastic limit when the actuator assembly strikes the buffer sheet. Thus, by only mounting the buffer sheet of the moving base, the elastic rods possibly are unexpectedly deformed plastically.

To overcome the above problem, one object of this invention is to provide an optical pick-up device, which can prevent sound noise and deformation of elastic rods for supporting the actuator assembly to move freely.

### SUMMARY OF THE INVENTION

How to Attain the Object

In order to attain the objects, an optical pick-up device according to an aspect of this invention is specified by having a moving base freely movable in a radial direction of an optical disk; an actuator assembly being mounted on the moving base so as to move freely in a direction to and from the optical disk and in the radial direction of the optical disk for reading data stored in the optical disk; an elastic rod for supporting the actuator assembly to move freely in the direction to and from the optical disk and in the radial direction of the optical disk, one end of the elastic rod being joined to the moving base, the other end of the elastic rod being joined to the actuator assembly; and a buffer sheet being mounted on the moving base so as to abut on the actuator assembly when the actuator assembly is moved apart from the optical disk. The buffer sheets are located at positions, between which a center of gravity of the actuator assembly exists in a plan view.

An optical pick-up device according to another aspect of this invention is specified by having a moving base freely movable in a radial direction of an optical disk; an actuator assembly being mounted on the moving base so as to move freely in a direction to and from the optical disk and in the radial direction of the optical disk for reading data stored in the optical disk; an elastic rod for supporting the actuator assembly to move freely in the direction to and from the optical disk and in the radial direction of the optical disk, one end of the elastic rod being joined to the moving base, the other end of the elastic rod being joined to the actuator assembly; and a buffer sheet being mounted on the moving base so as to abut on the actuator assembly when the actuator assembly is moved apart from the optical disk. The buffer sheets more than two are located at positions, among which a center of gravity of the actuator assembly exists in a plan view.

### DESCRIPTION OF THE BEST MODE

One embodiment of an optical pick-up device according to this invention will be described herein. In the optical pick-up device according to this embodiment, by mounting buffer sheets to position a center of gravity of an actuator assembly between the buffer sheets, it is prevented that elastic rods are twisted when viewed from top, and the elastic rods are deformed plastically.

According to this invention, the buffer sheets can be located separately to each other in a direction perpendicular to lengthwise of the elastic rod.

According to this invention, the buffer sheets can be located separately to each other in lengthwise of the elastic rod.

According to this invention, the buffer sheets more than two are located to position a center of gravity of the actuator assembly among the buffer sheets when viewed from top.

The above and other objects and features of this invention will become more apparent from the following description taken in conjunction with the accompanying drawings.

### BRIEF DESCRIPTION OF THE DRAWINGS

FIG. 1 is a plan view of an optical pick-up device of the first embodiment according to this invention;

FIG. 2 is a plan view of a pick-up portion of the optical pick-up device shown in FIG. 1;

FIG. 3 is a cross-sectional view taken along the III-III line in FIG. 2;

FIG. 4 is a partial plan view showing positional relation between an actuator assembly and a buffer sheet of the pick-up portion shown in FIG. 2;

FIG. 5 is a partial plan view showing positional relation between the actuator assembly and a modified buffer sheet of the pick-up portion shown in FIG. 4;

FIG. 6 is a partial plan view showing positional relation between an actuator assembly and a buffer sheet of an optical pick-up device of the second embodiment according to this invention;

FIG. 7 is a partial plan view showing positional relation between the actuator assembly and a modified buffer sheet of the pick-up portion shown in FIG. 6;

FIG. 8 is a partial plan view showing positional relation between an actuator assembly and a buffer sheet of an optical pick-up device of the third embodiment according to this invention;

FIG. 9 is a partial plan view showing positional relation between the actuator assembly and a modified buffer sheet of the pick-up portion shown in FIG. 8;

FIG. 10 is a partial plan view showing positional relation between the actuator assembly and an other modified buffer sheet of the pick-up portion shown in FIG. 8; and

FIG. 11 is a partial plan view showing positional relation between the actuator assembly and a further modified buffer sheet of the pick-up portion shown in FIG. 8.

### DESCRIPTION OF EMBODIMENTS

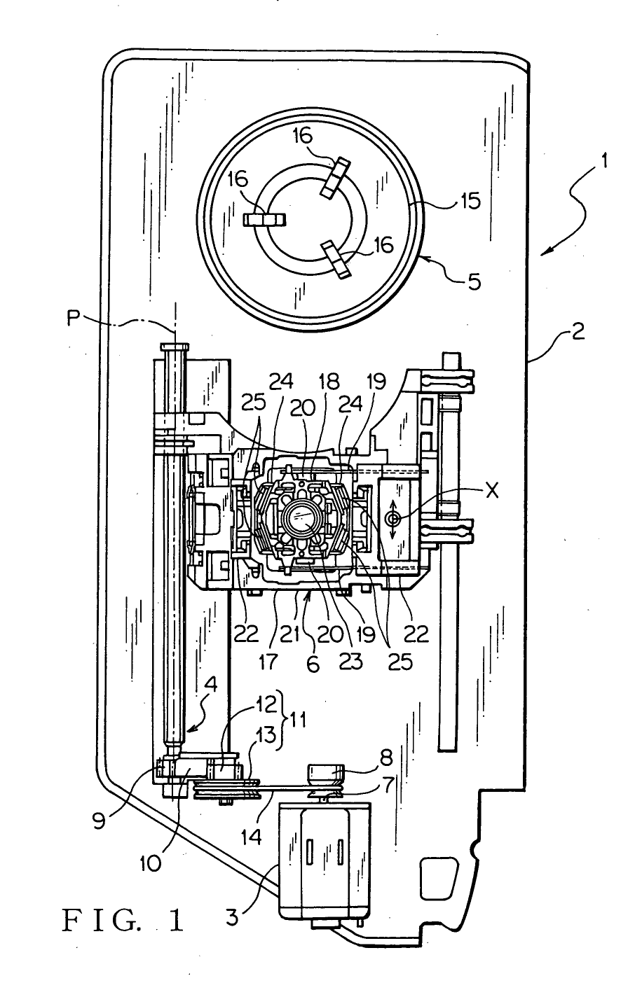

The first embodiment according to the present invention will be described with reference to FIGS. 1-4. An optical pick-up device 1 shown in FIG. 1 forms an optical disk playback apparatus to be installed in a car as a vehicle. The optical disk playback apparatus, such as a CD player and a DVD player reads data stored on an optical disk, such as a CD and DVD, and plays back the data. The optical pick-up device 1 reads out the data stored on the optical disk.

The optical pick-up device 1 has a chassis 2, a motor 3 as a driving source, a lead screw 4 as a screw shaft, a clamping mechanism 5 and a pick-up portion 6, as shown in FIG. 1.

The chassis 2 made of a sheet metal is formed into a flat-plate shape. The motor 3 is fixed on the chassis 2. An output shaft 7 of the motor 3 is joined with a pulley 8 as shown in FIG. 1. The lead screw 4 is formed into a bar shape extending along an alternate long and short dash line P (call an axis line hereafter) in FIG. 1. The lead screw 4 is supported rotatably about the axis line P by the chassis 2.

The lead screw 4 has a thread groove. The thread groove is formed on an outer surface of the lead screw 4. One end of the lead screw 4 is joined with a gear 9. The gear 9 engages with a transmission gear 10. The transmission gear 10 engages with a gear portion 12 of a rotary transmission body 11.

The rotary transmission body 11 is supported rotatably by the chassis 2. The rotary transmission body 11 includes integrally the gear portion 12 and a pulley 13 to be coaxial to each other. An endless belt 14 is laid between the pulleys 8, 13. The endless belt 14 is ring-shaped. According to the above structure, a rotary driving force of the motor 3 is transmitted through the pulley 8 and the pulley 13 to the gear 9, so that the lead screw 4 is rotated about the axis line P.

The clamping mechanism 5 includes a rotating table 15 and a plurality of out-in members 16 as shown in FIG. 1. The rotating table 15 is formed into a disk shape for mounting the optical disk on a top surface thereof. The rotating table 15 is coaxial with the optical disk on the top surface thereof. The rotating table 15 is rotated about an axis by a spindle motor (not shown)

The out-in member 16 is provided so as to stick out from the top surface of the rotating table 15 and sink in under the top surface. The out-in member 16 sticks out from the top surface of the rotating table 15 and locks with an inner edge of a center opening of the optical disk. After the out-in member 16 locks with the inner edge of the center opening of the optical disk, the clamping mechanism 5 clamps the optical disk, and the rotating table 5 is rotated.

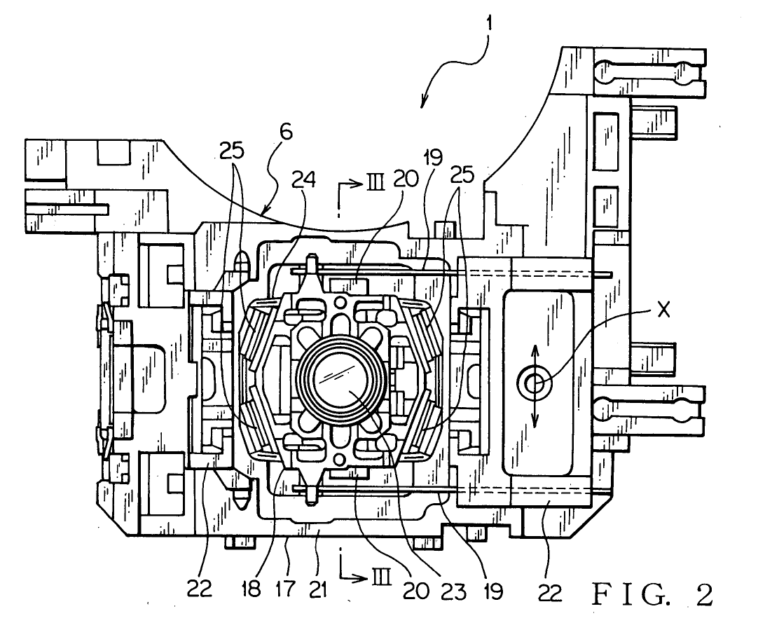

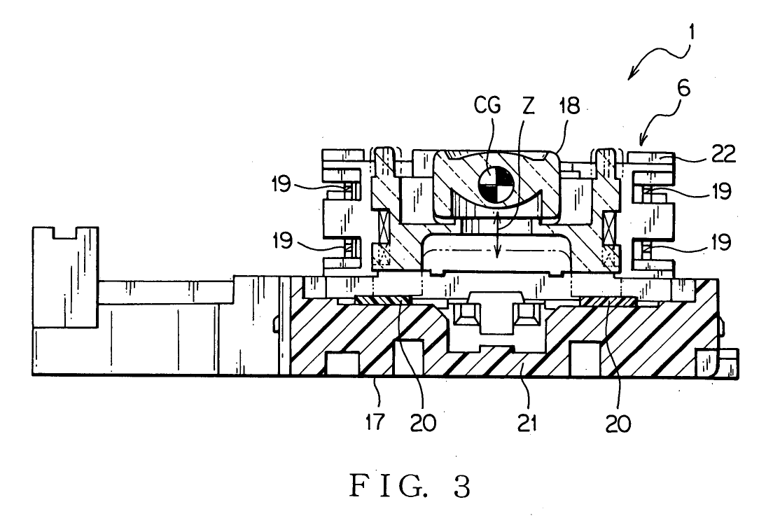

The pick-up portion 6 includes a moving base 17, an actuator assembly 18, an elastic rod 19 as shown in FIGS. 1-3 and a buffer sheet 20 shown in FIGS. 2, 3. The moving base 17 has integrally a thick flat-plate-shaped main body 21 and a pair of projections 22 provided at both ends of lengthwise of the main body 21.

One end of lengthwise of the main body 21 engages with the lead screw 4. The main body 21, that is, the moving base 17 approaches to and apart from the rotating table 15 by rotating the lead screw 4 about the axis line P so as to move in a radial direction of the optical disk clamped on the rotating table 15.

Thus, the moving base 17 is provided to move freely in the radial direction of the optical disk. The lengthwise of the main body 21 is perpendicular to the axis line P of the lead screw 4, that is, a moving direction of the moving base 17. The projections 22 project toward the optical disk clamped on the rotating table 15 from the both ends of lengthwise of the main body 21.

The actuator assembly 18 reads data stored on the optical disk. In the actuator assembly 18, an objective lens 23 (shown in FIG. 2) is located between the pair of projections 22 corresponding to a data storing surface of the optical disk clamped on the rotating table 15.

The actuator assembly 18 is provided at the moving base 17 so as to move freely in a direction Z to approach to and apart from the data storing surface of the optical disk and in the radial direction X of the optical disk clamped on the rotating table 15. The direction Z is a direction perpendicular to the surface of the optical disk, shown with an arrow in FIG. 3, called as a focusing direction hereafter. The direction X is shown with an arrow in FIG. 2, called as a tracking direction hereafter.

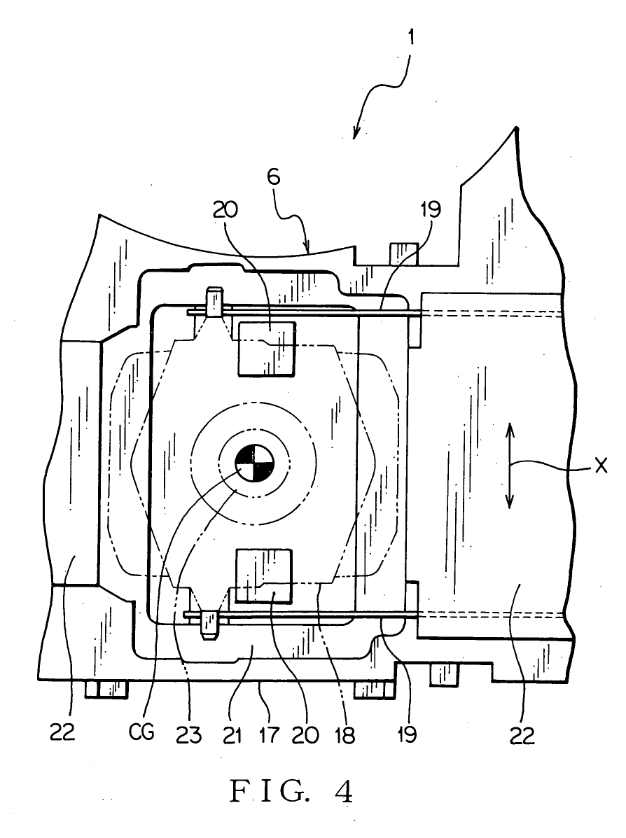

A center of gravity CG of the actuator assembly is located at the center of the objective lens 23 as shown in FIG. 4 when viewed from the top, and located at the center of the thickness of the objective lens 23 in cross section thereof, as shown in FIG. 3. In the actuator assembly 18, coils 24, 25 for moving the objective lens 23 in the focusing direction Z and the tracking direction X are wound.

The elastic rod 19 made of metal is formed into a rod having a rectangular shape in cross-section. The elastic rod 19 is manufactured by punching a thin sheet metal. One end of the elastic rod 19 is joined to the one of projections 22 of the moving base 17, and the other end of the elastic rod 19 is joined with the actuator assembly 18. The lengthwise of the elastic rod 19 is arranged perpendicular to the axis line P of the lead screw 4, that is, the moving direction of the moving base 17.

In this embodiment, the four elastic rods are provided. One pair of elastic rods 19 and the other pair of elastic rods 19 of the four elastic rods 19 are located separately to each other along the moving direction of the moving base 17. The pair of elastic rods 19 is located separately to each other in the direction Z. These elastic rods 19 are arranged in parallel to each other.

The elastic rods 19 in neutral condition not to be elastically deformed positions the actuator assembly 18 at the center of the pair of projections 22. The elastic rods 19 to be deformed elastically support the actuator assembly 18 to move freely in the focusing direction Z and in the tracking direction X.

The buffer sheet 20 is made of flexible resin and non-woven fabric, and formed into a sheet. In this embodiment, a pair of buffer sheets 20 is provided. The buffer sheets 20 are bonded on a surface of the main body 21 corresponding to the actuator assembly 18 between the pair of projections 22 of the moving base 17. The buffer sheet 20 is formed into a square in a plan view.

The pair of buffer sheets 20 is provided separately to each other in a direction perpendicular to lengthwise of the elastic rods 19, and located between an outer edge of the actuator assembly 18 and the main body 21, that is, below the outer edge of the actuator assembly 18. Thereby, the outer edge of the actuator assembly 18, which moves apart from the optical disk clamped on the rotating table 15 and approaches to the main body 21, that is, the moving base 17, abuts on the pair of buffer sheets 20.

Therefore, the buffer sheets 20 are located to place the center of gravity CG of the actuator assembly 18 therebetween. When the actuator assembly 19 approaches to the main body 21, that is, the moving base 17 in the focusing direction Z, the buffer sheets 20 abuts on the actuator assembly 18 to reduce a sound noise caused by clash of the actuator assembly 18 (prevent a sound noise).

According to the optical pick-up device 1 structured as mentioned above, clamping the optical disk on the rotating table 15, rotating the rotating table 15, moving the pick-up portion 6 along the axis line P, the actuator assembly 18 reads data of a required position on the data storing surface of the optical disk. The actuator assembly 18 moves in the focusing direction Z and in the tracking direction X by applying voltage to the coils 24, 25 so as to read data of the required position on the data storing surface of the optical disk.

In the optical pick-up device 1, voltage is not applied to the coils 24, 25 in a not-in-use condition not to read data of the optical disk. In case of installing the optical disk playback apparatus in a car, the actuator assembly 18 moves (vibrates) with relation to the moving base 17 in the focusing direction Z and in the tracking direction X by vibration of the running car. At the time, when the actuator assembly 18 approaches to the main body 21 of the moving base 17, the actuator assembly abuts on the buffer sheet 20 to prevent sound noise.

In this embodiment, the pair of buffer sheets 20 is provided separately to each other in the direction perpendicular to lengthwise of the elastic rods 19 to position the center of gravity CG of the actuator assembly 18 therebetween in a plan view. When the actuator assembly 18 approaches to the moving bas 17 to abut on the moving base 17, the actuator assembly 18 touches at the same time on the pair of buffer sheets 20 provided at pair of positions. Thereby, when the actuator assembly 18 abuts on the buffer sheet 20, it is prevented that the elastic rod 19 is twisted.

Thus, the elastic rod 19 is prevented from plastic deformation, and sound noise is prevented.

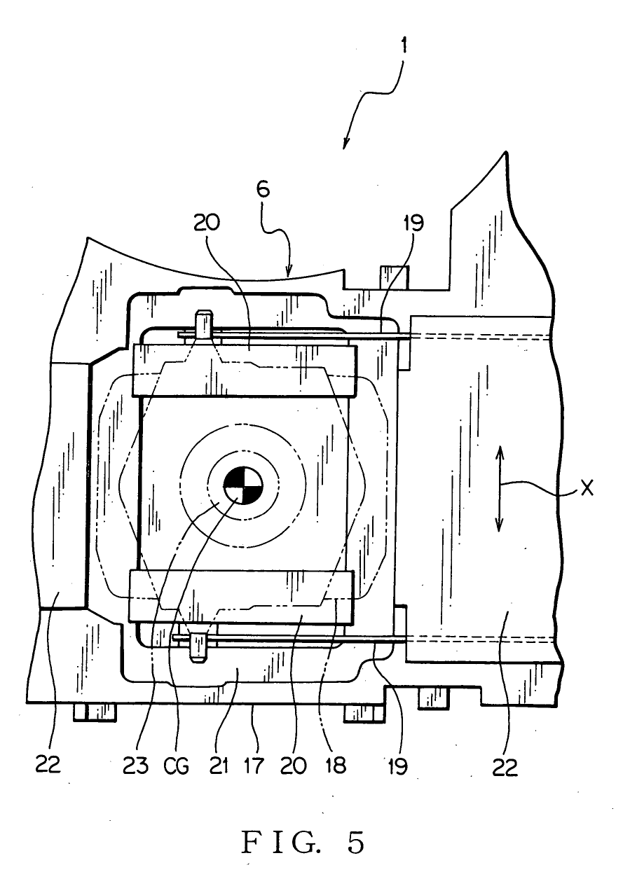

In this embodiment, the buffer sheet 20 is formed into a square-shape. According to the present invention, the buffer sheet 20 can be formed into a rectangular shape as shown in FIG. 5. In FIG. 5, the same parts as that in the first embodiment are given with the same markings and description about them is omitted. In FIG. 5, the buffer sheets 20 are provided to place the center of gravity CG of the actuator assembly 18 therebetween in a plan view. The pair of buffer sheets 20 is provided separately in the direction perpendicular to lengthwise of the elastic rods 19. Lengthwise of each buffer sheets 20 is aligned in parallel to lengthwise of the elastic rods 19. Thereby, plastic deformation of the elastic rods 19 is prevented.

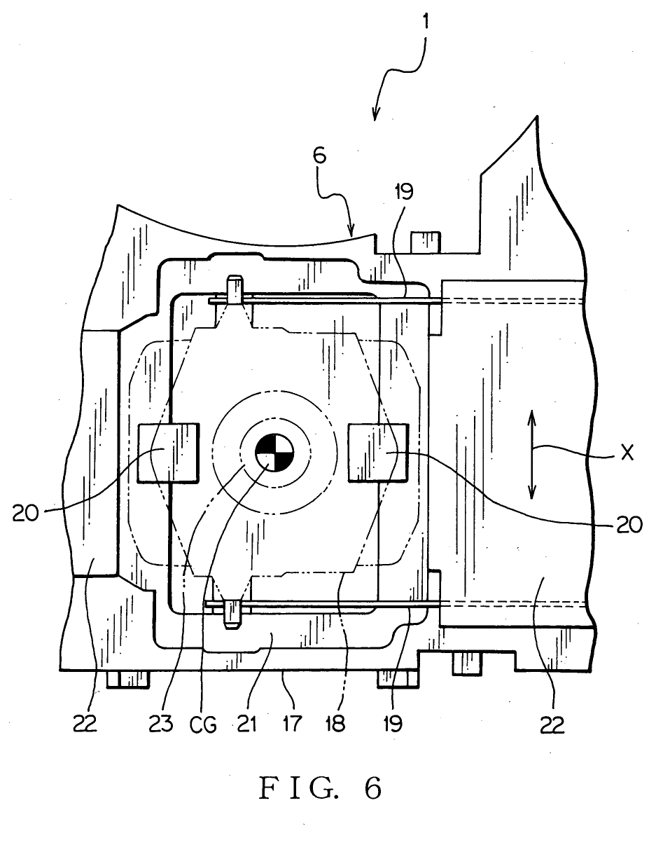

The second embodiment according to the present invention will be described with FIG. 6. The same parts as that in the first embodiment are given with the same marking and description about them is omitted.

According to this embodiment, a pair of buffer sheets 20 formed into a square shape in a plan view is provided. The pair of buffer sheets 20 is located separately to each other in lengthwise of the elastic rods 19, and placed between the outer edge of the actuator assembly 18 and the main body 21, that is, under the outer edge of the actuator assembly 18. Thereby, the pair of buffer sheets 20 abuts on the outer edge of the actuator assembly 18, which approaches to the main body 21, that is, the moving base 17 apart from the optical disk clamped on the rotating table 15.

The buffer sheets 20 are located to place the center of gravity CG of the actuator assembly 18 therebetween in a plan view as shown in FIG. 6. When the actuator assembly 19 approaches to the main body 21, that is, the moving base 17 in the focusing direction Z, the buffer sheets 20 abuts on the actuator assembly 18 to reduce a sound noise caused by clash of the actuator assembly 18 (prevent a sound noise).

In this embodiment, the pair of buffer sheets 20 is provided separately to each other in the direction perpendicular to lengthwise of the elastic rods 19 to position the center of gravity CG of the actuator assembly 18 therebetween in a plan view. When the actuator assembly 18 approaches to the moving bas 17 to abut on the moving base 17, the actuator assembly 18 touches at the same time on the pair of buffer sheets 20 provided at pair of positions. Thereby, when the actuator assembly 18 abuts on the buffer sheet 20, it is prevented that the elastic rod 19 is twisted.

Thus, the elastic rod 19 is prevented from plastic deformation, and sound noise is prevented.

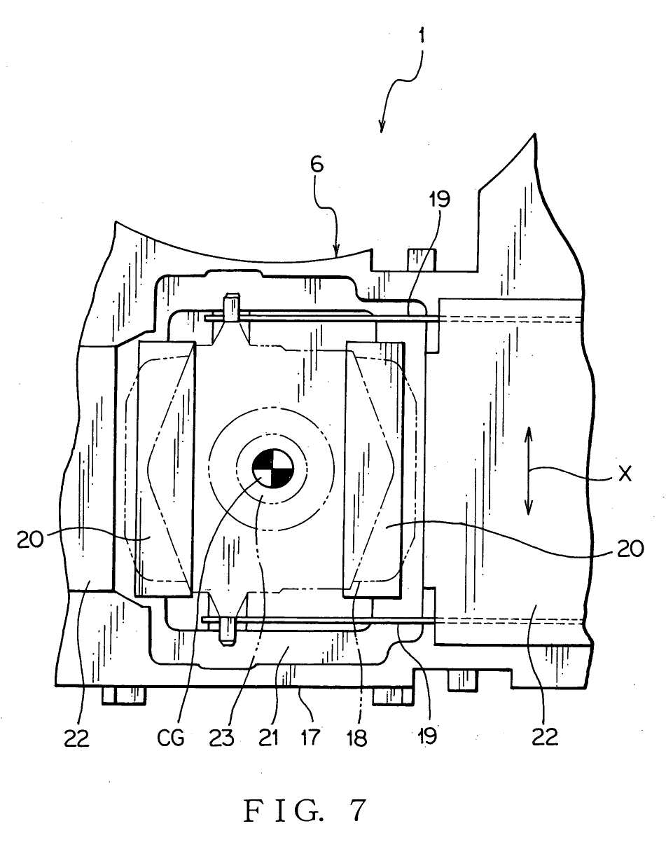

In second embodiment, the buffer sheet 20 is formed into a square-shape. According to the present invention, the buffer sheet 20 can be formed into a rectangular shape as shown in FIG. 7. In FIG. 7, the same parts as that in the second embodiment are given with the same markings and description about them is omitted. In FIG. 7, the buffer sheets 20 are provided to place the center of gravity CG of the actuator assembly 18 therebetween in a plan view. The pair of buffer sheets 20 is provided separately in the direction perpendicular to lengthwise of the elastic rods 19. Lengthwise of each buffer sheets 20 is aligned in parallel to lengthwise of the elastic rods 19. Thereby, plastic deformation of the elastic rods 19 is prevented.

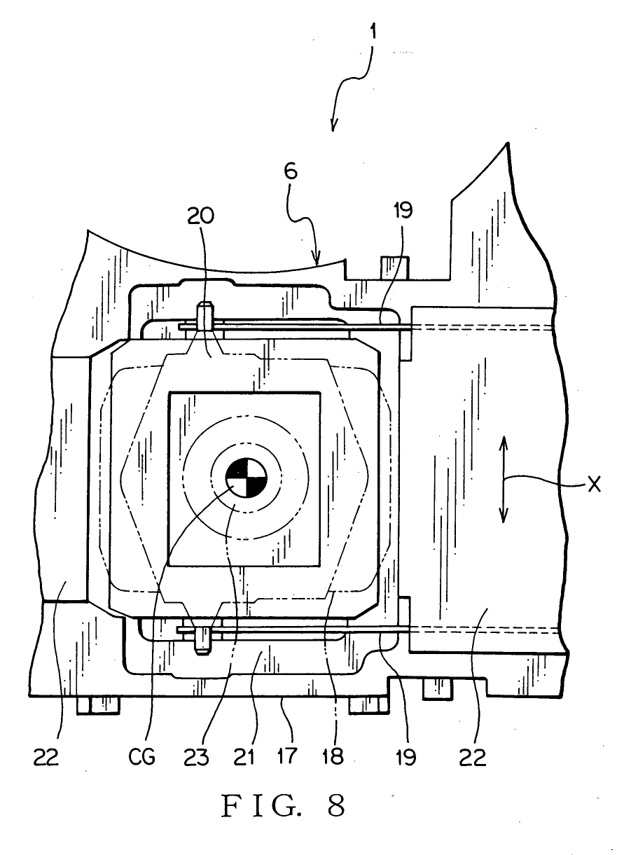

The third embodiment according to the present invention will be described with FIG. 8. The same parts as that in the first and second embodiments are given with the same marking and description about them is omitted.

According to this embodiment, the buffer sheets 20 is formed into a square frame shape in a plan view. The buffer sheets 20 is provided around the actuator assembly 18 between the outer edge of the actuator assembly 18 and a surface of the main body 21, that is, under the outer edge of the actuator assembly 18. Thereby, the buffer sheets 20 abuts on the outer edge of the actuator assembly 18, which approaches to the main body 21, that is, the moving base 17 apart from the optical disk clamped on the rotating table 15.

The buffer sheets 20 are provided to place the center of gravity CG of the actuator assembly 18 therein in a plan view as shown in FIG. 8. Two pairs of sides of the buffer sheet 20 are located separately to each other in lengthwise of the elastic rod 19 and in a direction perpendicular to the lengthwise of the elastic rods 19. Thus, the buffer sheet 20 is located at three positions or more surrounding the center of gravity CG of the actuator assembly 18 in a plan view as shown in FIG. 8. When the actuator assembly 19 approaches to the main body 21, that is, the moving base 17 in the focusing direction Z, the buffer sheets 20 abuts on the actuator assembly 18 to reduce a sound noise caused by clash of the actuator assembly 18 (prevent sound noise).

In this embodiment, the buffer sheets 20 is provided at three positions or more surrounding the center of gravity CG of the actuator assembly 18 in a plan view. Thereby, when the actuator assembly 18 abuts on the buffer sheet 20, it is prevented that the elastic rod 19 is twisted.

Thus, the elastic rod 19 is prevented from plastic deformation, and sound noise is prevented.

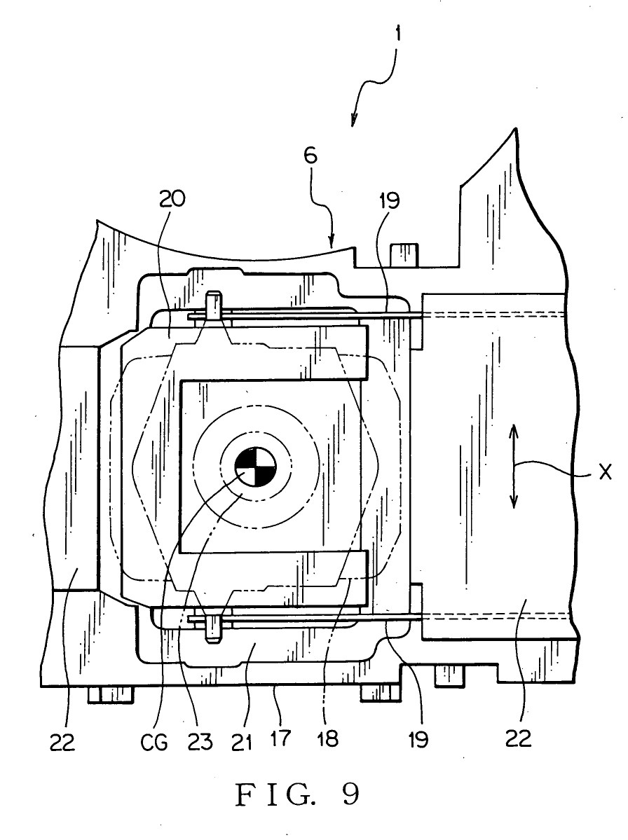

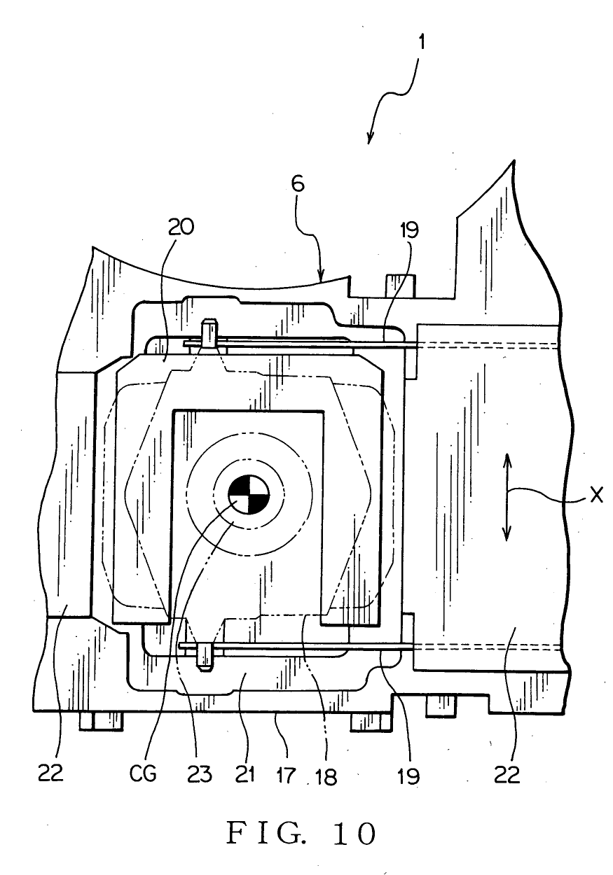

In this embodiment, the buffer sheets 20 can be formed into U-shape as shown in FIGS. 9, 10. In FIGS. 9, 10, the same parts as that in the third embodiment are given with the same marking and description about them is omitted.

In the embodiment shown in FIG. 9, the buffer sheets 20 is provided at three points or more surrounding the center of gravity CG of the actuator assembly 18 to place the center of gravity CG of the actuator assembly 18 among the buffer sheets 20 in a plan view, and to be separated to each other in a direction perpendicular to lengthwise of the elastic rods 19.

In the embodiment shown in FIG. 10, the buffer sheets 20 is provided at three points or more surrounding the center of gravity CG of the actuator assembly 18 to place the center of gravity CG of the actuator assembly 18 among the buffer sheets 20 in a plan view, and to be separated to each other in a direction of lengthwise of the elastic rods 19.

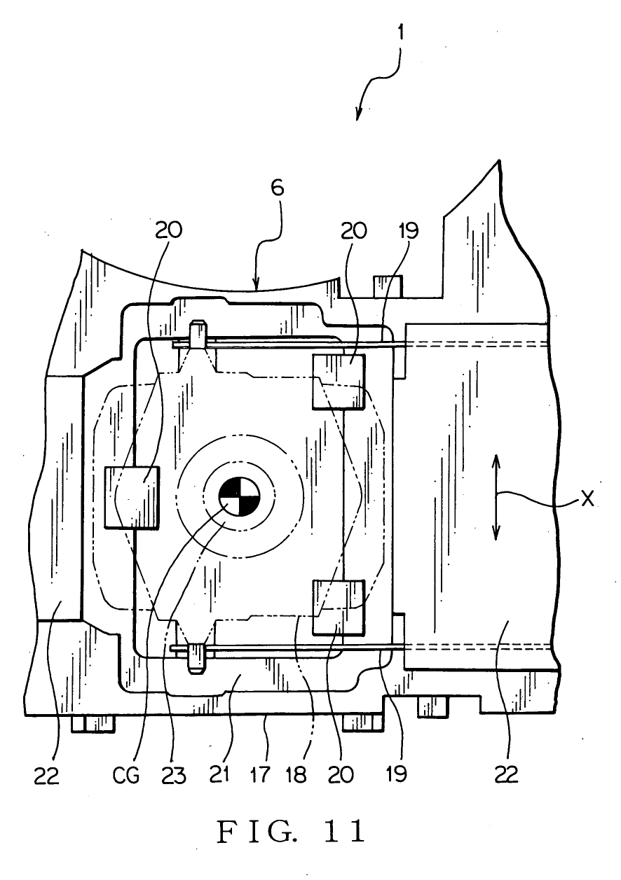

In the embodiment, as shown in FIG. 11, a plurality of buffer sheets 20 formed into a square shape in a plan view can be provided at three points or more surrounding the center of gravity CG of the actuator assembly 18 to place the center of gravity CG of the actuator assembly 18. In FIG. 11, three buffer sheets 20 are provided.

In the embodiment shown in FIGS. 9, 10 and 11, the buffer sheets 20 is provided at three positions or more surrounding the center of gravity CG of the actuator assembly 18 in a plan view. Thereby, when the actuator assembly 18 abuts on the buffer sheet 20, it is prevented that the elastic rod 19 is twisted.

In the embodiment mentioned above, the optical pick-up device 1 forms an optical disk playback apparatus to be installed in a car as a vehicle. According to the present invention, the optical pick-up device 1 can be applied to various optical disk playback apparatuses placed in a house.

According to the aforesaid embodiment, following optical pick-up devices 1 can be provided.

Type 1: The optical pick-up device 1 includes a moving base 17 freely movable in a radial direction of an optical disk; an actuator assembly 18 being mounted on the moving base 17 so as to move freely in a direction Z to and from the optical disk and in the radial direction X of the optical disk for reading data stored in the optical disk; an elastic rod 19 for supporting the actuator assembly 18 to move freely in the direction Z to and from the optical disk and in the radial direction X of the optical disk, one end of the elastic rod being joined to the moving base, the other end of the elastic rod being joined to the actuator assembly; and a buffer sheet 20 being mounted on the moving base so as to abut on the actuator assembly 18 when the actuator assembly 18 is moved apart from the optical disk, and the buffer sheets 20 are located at positions between which a center of gravity CG of the actuator assembly 18 exists in a plan view.

Type 2: The optical pick-up device 1 according to type 1 optical pick-up device is specified by that a pair of the buffer sheets 20 is located separately to each other in a direction perpendicular to lengthwise of the elastic rod 19.

Type 3: The optical pick up device 1 according to type 1 optical pick-up device is specified by that a pair of the buffer sheets 20 is located separately to each other in lengthwise of the elastic rod 19.

Type 4: The optical pick-up device 1 includes a moving base 17 freely movable in a radial direction of an optical disk; an actuator assembly 18 being mounted on the moving base 17 so as to move freely in a direction Z to and from the optical disk and in the radial direction X of the optical disk for reading data stored in the optical disk; an elastic rod 19 for supporting the actuator assembly 18 to move freely in the direction Z to and from the optical disk and in the radial direction X of the optical disk, one end of the elastic rod being joined to the moving base, the other end of the elastic rod being joined to the actuator assembly; and a buffer sheet 20 being mounted on the moving base so as to abut on the actuator assembly 18 when the actuator assembly 18 is moved apart from the optical disk, and buffer sheets 20 more than two are located at positions, among which a center of gravity CG of the actuator assembly 18 exists, in a plan view.

The above mentioned embodiments are only typical examples according to the present invention, and the invention is not limited to the embodiments. Various modifications can be made without departing from the scope of the present invention.

1. An optical pick-up device comprising:
a moving base freely movable in a radial direction of an optical disk;
an actuator assembly being mounted on said moving base so as to move freely in a direction to and from the optical disk and in the radial direction of the optical disk for reading data stored in the optical disk;
an elastic rod for supporting the actuator assembly to move freely in the direction to and from the optical disk and in the radial direction of the optical disk, one end of said elastic rod being joined to the moving base, the other end of said elastic rod being joined to the actuator assembly; and
a buffer sheet being mounted on the moving base so as to abut on the actuator assembly when the actuator assembly is moved apart from the optical disk,
whereby said buffer sheets are disposed at positions, between which a center of gravity of the actuator assembly exists in a plane geometry.

2. The optical pick-up device according to claim 1, wherein a-pair of said buffer sheets is disposed separately to each other in a direction perpendicular to lengthwise of the elastic rod.

3. The optical pick-up device according to claim 1, wherein a pair of said buffer sheets is disposed separately to each other in lengthwise of the elastic rod.

4. An optical pick-up device comprising:
a moving base freely movable in a radial direction of an optical disk;
an actuator assembly being mounted on said moving base so as to move freely in a direction to and from the optical disk and in the radial direction of the optical disk for reading data stored in the optical disk;
an elastic rod for supporting the actuator assembly to move freely in the direction to and from the optical disk and in the radial direction of the optical disk, one end of said elastic rod being joined to the moving base, the other end of said elastic rod being joined to the actuator assembly; and
a buffer sheet being mounted on the moving base so as to abut on the actuator assembly when the actuator assembly is moved apart from the optical disk,
whereby said buffer sheets more than two are disposed at positions, among which a center of gravity of the actuator assembly exists in a plane geometry.
